(19) United States
(12) Patent Application Publication
(10) Pub. No.: US 2022/0137620 A1
(43) Pub. Date: May 5, 2022

(54) COMMUNICATION STATUS SYSTEM AND METHOD

(71) Applicant: Transportation IP Holdings, LLC, Norwalk, CT (US)

(72) Inventors: Charles L. Wolf, Olney, MD (US); Paul Gerard Bender, Clarksburg, MD (US); Richard S. Klemanski, Walkersville, MD (US)

(21) Appl. No.: 17/575,487

(22) Filed: Jan. 13, 2022

Related U.S. Application Data
(63) Continuation-in-part of application No. 16/577,964, filed on Sep. 20, 2019, now Pat. No. 11,265,284.
Application No. 16/577,964 is a continuation-in-part of application No. 15/073,929, filed on Mar. 18, 2016, now Pat. No. 10,530,676.
Application No. 15/073,929 is a continuation-in-part of application No. 15/481,817, filed on Apr. 7, 2017, now Pat. No. 10,479,382.

(51) Int. Cl. G05D 1/00; H04L 1/16

(52) U.S. Cl. CPC G05D 1/0027; G05D 1/0295; H04L 1/1607; G05D 1/0022

(57) ABSTRACT

Communication systems and methods for vehicles are provided. A method includes receiving a command message from a first vehicle at a second vehicle, wherein the first vehicle and second vehicle are communicatively coupled to define at least a portion of a vehicle group; receiving a status reply message from the second vehicle at the first vehicle in response to a trigger event; controlling an operation of one or more vehicles in the vehicle group based at least in part on a determined communications status of a communication network comprising at least one communication device with respect to the command message and the status reply message.

### CROSS-REFERENCE TO RELATED APPLICATIONS

This application is a continuation-in-part application claiming priority to U.S. patent application Ser. No. 16/577,964 (filed 20 Sep. 2019), which is a continuation-in-part application claiming priority to U.S. patent application Ser. No. 15/073,929 (filed 18 Mar. 2016, now U.S. Pat. No. 10,530,676) and is a continuation-in-part application claiming priority to U.S. patent application Ser. No. 15/481,817 (filed 7 Apr. 2017, now U.S. Pat. No. 10,479,382). The entire contents of these applications are hereby incorporated by reference.

### BACKGROUND

### Technical Field

Embodiments of the invention relate to a communication system for vehicles and an associated method.

### Discussion of Art

Communication among mobile assets may be useful to ensure the coordination of various functions of the mobile assets. With regard to vehicles, such functions may include throttle control, braking, and direction. These may help to coordinate during operation. Radio frequency schemes may be used communication, with various combinations of communication devices and arrangements, e.g., transmitters, receivers, transceivers, and/or the like, distributed among the vehicles.

Upon receipt of the command message, a vehicle may transmit a reply message. The message may include actual status information, particularly as pertaining to the command message instructions. The absence or presence of a reply does not necessarily mean that vehicles are not following the command message instruction.

In one example, a vehicle in a vehicle group may traverse a wide range of topographies including mountainous terrain and other areas having physical features, such as tunnels, that may cause a temporary loss of communication. When traveling through such areas, an operator may interpret the lack of a status reply message from another vehicle to mean a proper command message information was not received or understood. However, it may be the case that the reply message was not received because the reply message was lost due to a temporary communication failure. In this respect, the remote vehicle may be following the command message instructions despite an erroneous conclusion that the remote vehicle is not following the command message instructions. It may be desirable to have a system and method that differs from those that are currently available.

### BRIEF SUMMARY

According to one embodiment, a system is provided that includes a first controller that can receive a command message from a first vehicle at a second vehicle, wherein the first vehicle and second vehicle are communicatively coupled to define at least a portion of a vehicle group; a second controller that can receive a status reply message from the second vehicle at the first vehicle in response to a trigger event, and at least one of the first and second controllers that can operate one or more vehicles in the vehicle group based at least in part on a determined communications status of a communication network comprising at least one communication device with respect to the command message and the status reply message.

In one embodiment, a method is provided that includes receiving a command message from a first vehicle at a second vehicle, wherein the first vehicle and second vehicle are communicatively coupled to define at least a portion of a vehicle group; receiving a status reply message from the second vehicle at the first vehicle in response to a trigger event; controlling an operation of one or more vehicles in the vehicle group based at least in part on a determined communications status of a communication network comprising at least one communication device with respect to the command message and the status reply message.

According to one aspect or embodiment, a method is provided that includes transmitting, by a lead communication device of a lead vehicle, a command message; receiving, by a plurality of communication devices of a respective plurality of remote vehicles, the command message; transmitting, by a communication device of at least one remote vehicle of the plurality of remote vehicles, a status reply message in response to receipt of the command message, wherein at least a portion of the command message is repeated within the status reply message; receiving, by a communication device of at least one other remote vehicle of the plurality of remote vehicles, the status reply message including the repeated at least a portion of the command message; incrementing, at the at least one other remote vehicle of the plurality of remote vehicles, a current status reply count in response to the receipt of the status reply message including the repeated at least a portion of the command message from the at least one remote vehicle of the plurality of remote vehicles; and transmitting, by the communication device of the at least one other remote vehicle of the plurality of remote vehicles, an expanded status reply message including the current status reply count to the lead communication device of the lead vehicle; receiving, by the lead communication device of the lead vehicle, the expanded status reply message; determining, by an on-board processor of the lead vehicle, a communications status of a communication device of the at least one remote vehicle with respect to the command message, based at least partly on the current status reply count in the expanded status reply message received from the at least one other remote vehicle; and controlling, by the on-board processor of the lead vehicle, at least one of a throttle and a brake of the vehicle group based on the determined communications status of the communication device of the at least one remote vehicle with respect to the command message.

### BRIEF DESCRIPTION OF THE DRAWINGS

Further features and aspects of the invention are disclosed in the following detailed description made with reference to the drawings in which:

FIG. 1 is a schematic diagram of a portion of a vehicle group according to an aspect of the invention;

FIG. 2 is an example diagrammatic representation of a message structure including data indicative of a count;

FIG. 3 illustrates example diagrammatic representations of a command message;

FIG. 4 is a flow chart showing a system and process for transmitting a command message;

FIG. 5 is a flow chart showing a system and process for receiving a message at a remote unit;

FIG. 6 is a flow chart showing a system and process for receiving remote status messages by a vehicle;

FIG. 7 is a data structure of a command message according to an embodiment;

FIG. 8 is a data structure of a response message according to an embodiment; and

FIG. 9 is a flow diagram for determining a communication status of vehicles in a vehicle group according to the principles of the invention.

### DETAILED DESCRIPTION

Embodiments of the invention relate to a communication system for vehicles and an associated method. In one embodiment, a method is provided that includes receiving a command message from a first vehicle at a second vehicle, wherein the first vehicle and second vehicle are communicatively coupled to define at least a portion of a vehicle group; receiving a status reply message from the second vehicle at the first vehicle in response to a trigger event; controlling an operation of one or more vehicles in the vehicle group based at least in part on a determined communications status of a communication network comprising at least one communication device with respect to the command message and the status reply message.

At least a portion of the command message may be repeated within the status reply message. The status reply message may include a command received count that represents a number of times that the status reply message has been received from at least one vehicle in the vehicle group. A controller may determine a communications status of the communication device based at least partly on the command received count. The message source indicator may include a semaphore.

In one embodiment, a status reply message may be modified to create an expanded status reply. In an expanded status reply a first status reply and a second status reply may be included. Each of the first and second status replies may be with respect to different vehicles in the vehicle group. The communication status of the communication network may be determined based on the status replies. The communication status may be referred to as the communication network heath.

The communication device may be at least a first communication device of a plurality of communication devices and the first communication device may be disposed on the first vehicle. The determination may be based at least partly on a number or count of status reply messages received by the first communication device of the first vehicle.

The second vehicle may be one of several remote vehicles, all of which (remote and lead vehicles) may be members of the vehicle group. The method may include confirming or logging receipt of the command message by one or more of the remote vehicles based at least in part on a respective status reply message from the one or more of the remote vehicles. The controller may use the command message to control at least one of a throttle or power consumption rate, brake, steering, yaw, and/or elevation of one or more vehicles in the vehicle group at least partly in response to the confirmed or logged receipt of the command message by changing one or more operational characteristics of the vehicle(s) based on or responsive to receiving the command message. The operational characteristics that may be controlled may depend on application specific parameters, such as the type of vehicle that is operating as a controller of other vehicles. Suitable vehicle types may include automobiles, over-the-road (OTR) trucks, marine vessels, rail vehicles (such as locomotives), mining, agricultural and construction equipment, and aircraft. In one embodiment, the vehicles are aerial drones. In one embodiment, the vehicles are locomotives. In one embodiment, the vehicles are of different types relative to each other. For example, one vehicle may be an automobile, another vehicle may be an aerial drone, another vehicle may be a truck, and the like, with these vehicles communicating with each other to coordinate their movements as described herein. For vehicles having fuel consuming engines, the term throttle refers to the amount of power being generated by the engine. Derivative functions of power generation may include vehicle speed, torque, emissions production, and the like. On the other hand, a vehicle having energy storage devices, such as a battery bank, may behave similarly but differ in that the expenditure of charge or power from the battery may influence vehicle speed, torque, and the like. In the case of a fuel cell, there is a similar consumption of fuel and power generation. For the sake of simplicity, the terms throttle and power consumption rate may be used somewhat interchangeably but may be application specific in some aspects as they depend on the type(s) of power source(s) for the vehicle.

In one embodiment, an on-board controller of the first vehicle may control at least one of a throttle or power consumption rate (as noted above), brake, steering, yaw, and/or elevation of at least one other vehicle (e.g., a second or controlled vehicle) in the vehicle group. The second vehicle may, in one embodiment, voluntarily allow the first vehicle to control the second vehicle or, if the second vehicle is already being controlled by the first vehicle, the second vehicle may take back control of the second vehicle from the first vehicle. Once in control, the controller (remotely located from the controlled or second vehicle) may perform actions in a less restrictive manner. For example, the controller may determine that the controlled vehicle received the command message and/or that the receipt of the command message by the controlled vehicle is confirmed. In response to this determination, the controller may then control the vehicle(s) in a less restrictive manner (e.g., by controlling the vehicles to move faster, move closer together, begin braking later, etc.). Conversely, the controller may determine that the controlled vehicle did not receive the command message and/or that the receipt of the command message by the controlled vehicle was not confirmed. In response to this determination, the controller may then control the vehicle(s) in a more restrictive manner (e.g., by controlling the vehicles to stop moving, to move slower, to move farther apart, to begin braking sooner, etc.). As another example, a low quality of service communication network may induce the controller to change an operational state of the vehicle group that provides extra distance between vehicles, slows down vehicle speeds, provides extra slack in groupings, takes corners wider, and the like, relative to a higher quality of service communication.

In a situation where the communication device is a first communication device of several communication devices, the method may include determining that the first communication device has not received a respective status reply message from a second communication device that is associated with at least a second vehicle; and determining a communications status of the second communication device based at least partly on the current status reply count in an expanded status reply message.

In one embodiment, the method may include delaying, for a determined period of time, designation of the communication status of the second communication device. In this manner, a false designation of communication failure is not determined. For example, instead of designating or identifying a communication failure immediately or very soon after no receiving a status reply message, the method may include waiting for a designated period of time before making this designation or identification. During this period of time, the status reply message may be received (thereby indicating that there is no communication failure). As a result, the method may not designate or identify the communication failure unless or until no status reply message is received within the period of time following transmission of a command message. Further, if a vehicle's communication device is out of communication for a determined time, the communication system may begin to attempt communication with regard at least to the status of that vehicle's communication device to other communication devices. Upon successful contact, the designation of the temporarily unavailable communication device may be reset to a functioning and available communication device.

The status reply message may be generated periodically without prompting from receipt of a command message. Further, it may be determined whether the at least one communication device of a second vehicle has received the command message; and the command message may be transmitted from the first vehicle until a controller determines that the communication device of the second vehicle has received the command message.

In one embodiment, the inventive system may switch modes of the first vehicle and the second vehicle such that the second vehicle transmits the command message, and the first vehicle receives the command message from the second vehicle, and the first vehicle responds to receipt of the command message by generating and transmitting a status reply message to the second vehicle. This may occur if the first or lead vehicle has the communication device that is unavailable. Another communication device may take the responsibility and the corresponding second controller may then begin to control the movement and operation of the vehicle group. For example, during a first period of time, a vehicle group that includes at least a first vehicle and a second vehicle, with the first vehicle controlling movement of the second vehicle by issuing command messages to the second vehicle. The second vehicle may switch states to being the vehicle that sends the command messages to the first vehicle (and thereby controls movement of the first vehicle) responsive to the communication device of the first vehicle (or a communication device of a third vehicle that relays or repeats messages) being unable to send or relay messages.

The on-board controller or processor(s) of the first vehicle may determine whether at least one of two or more communication devices of a respective two or more remote second vehicles has not received the command message. The controller may generate or provide an output to an operator of the first vehicle indicating at least one of the following: i) receipt of the command message by each of the two or more communication devices of the respective two or more remote second vehicles is confirmed and/or ii) receipt of the command message by one or more of the two or more remote second communication devices of a respective two or more remote second vehicles cannot be confirmed.

A controller may determine whether the received command message is a new command message or a previously received command message. The controller may determine a location of at least one second vehicle and/or of the first vehicle based at least in part on the current status reply count. For example, the location of the second vehicle may be determined to be ten vehicles away from the first vehicle responsive to the current status reply count being nine (e.g., indicating that nine vehicles between the second vehicle and the first vehicle relayed the status reply count from the second vehicle to the first vehicle). The controller may determine the location to be a relative location (e.g., that the second vehicle is ten vehicles away from the first vehicle) or an absolute location (e.g., that the second vehicle is at a geographic coordinate that is ten vehicles away from a location of the first vehicle).

In one embodiment, a system is provided that includes a second controller that can receive a command message from a first vehicle at a second vehicle. The first vehicle and the second vehicle may be communicatively coupled to define at least a portion of the vehicle group. A first controller can receive a status reply message from the second vehicle at the first vehicle in response to a trigger event. The first controller and/or second controller can operate one or more vehicles in the vehicle group based at least in part on a determined communications status of a communication network having at least one communication device with respect to the command message and the status reply message. For example, the first controller onboard the first vehicle can determine that the communication network has a functional, expected, or healthy status responsive to receiving a reply from the second controller (indicating receipt of a prior signal from the first controller) and/or responsive to a status reply count sent from the second controller indicating that all or substantially all of the vehicles in the vehicle group received a prior signal from the first controller. The status reply message may include additional data than the count. In one embodiment, the status reply message may include, for example, one or both of information about a signal strength and a distance between the communication device and the controlled vehicle. The distance may indicate an attenuation level of signal between the communication device and the controlled vehicle(s).

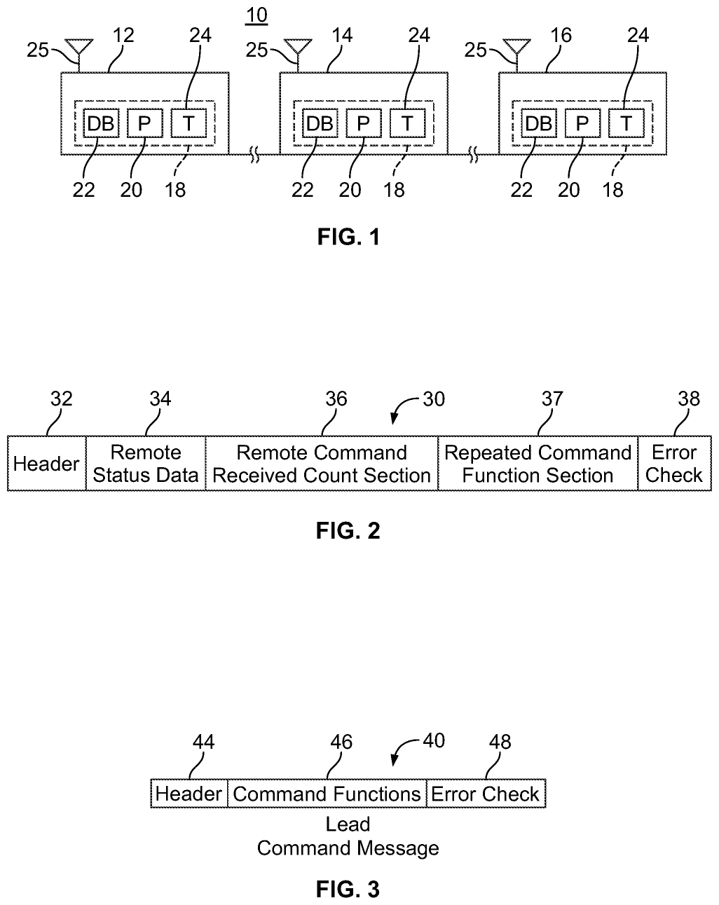

FIG. 1 is a schematic diagram of a portion of a vehicle group 10. By way of example, the vehicle group 10 may include a command vehicle 12, a first remote vehicle 14, and a second remote vehicle 16. The command vehicle may be referred to as a commanding vehicle, a control vehicle, a controlling vehicle, or the like. Optionally, the vehicle group may include only one remote vehicle or may include more than two remote vehicles. Also, optionally, the controller may be stationary and not supported on a vehicle at all. And, in one embodiment, the designation of commanding vehicle (or rather the location of a command controller) may be dynamically reassigned. Re-assignation may be useful to address component failure, communication loss, attenuation by distance between the commanding and commanded vehicles, and the like. The remote vehicles may be referred to as commanded vehicles, controlled vehicles, or the like. In the illustrated embodiment, the vehicles are shown as locomotives. In the illustrated embodiment, a plurality of railcars has been situated between the locomotives. In other embodiments, suitable other vehicles may include automobiles, OTR trucks, mining equipment, construction equipment, marine vessels, aircraft, and the like. The number and type of remote vehicles may be selected based on application specific parameters.

The command vehicle may be static (a single unchanging vehicle) or may be dynamic and may be different designated or determined vehicles. For example, the command vehicle may remain as the same vehicle throughout a trip of the vehicle group when the command vehicle remains static. Alternatively, the command vehicle may be dynamic in that the command vehicle may be the vehicle 10 for part of the trip, the vehicle 16 for another part of the trip, and so on. This dynamic change of command status from one vehicle to another may be in response to application specific parameters. Such parameters may include a fault or failure of communication equipment, the removal of the command vehicle from the vehicle group, and other like triggers.

Each vehicle may include an on-board controller 18. Suitable on-board control systems may include one or more of an edge-based system, an on-board computer, a vehicle management computer, a computing system, a computing device, one or more processors, and/or the like). In one embodiment, the controller may include at least one on-board processor 20 (or processing unit) and at least one database 22, which processor(s) may be programmed or configured to control and/or manage various systems or components on-board each vehicle and/or throughout the vehicle group. Each controller 18 may include, control, or be in communication with certain combinations of communication devices 24. Suitable communication devices may include one or more wireless communication devices, communication units, radio transmitters, receivers, and/or transceivers, programmed or configured for enabling wireless communication by and among the vehicles in the vehicle group. One or more antennae 25 may be provided for each vehicle to operate with the radio systems.

The controller of the command vehicle may be programmed or configured to function as the controlling device (or vehicle management computer) of a distributed power communication scheme, such as one designed and implemented by Wabtec—Westinghouse Air Brake Corporation. The lead vehicle controller may be configured for, among other things, transmitting command instructions within a command message to the remote vehicles. A command message may include command instructions to be executed, implemented, or acted upon by the remote vehicles in accordance or compliance with the distributed power communication scheme. Command instructions may include direct or indirect commands, direction commands, traction commands, dynamic braking commands, air brake commands, and/or any other commands relating to electrical and/or pneumatic functions of the vehicle group. For example, the command instruction may be a control instruction that the command vehicle transmits to at least one of the remote vehicles. The control instruction may direct a change in throttle settings, brake settings, brake pressure, speed, or the like.

The command vehicle may transmit to all or some of the remote vehicles repeatedly (e.g., periodically or in a non-periodic manner). Different vehicles may need different rates of periodicity. Further, different operating modes of the vehicles and different environmental factors affecting the vehicles may need different rates of periodicity. Suitable periodicity may be selected based on application specific parameters. In one embodiment, the periodicity may be in a range of from about ten seconds to about thirty seconds if there are no command changes. At other times, the controller may be in a receive mode (e.g., listening for messages from the remote vehicles). If a command change is determined, the controller of the commanding vehicle may transmit the associated command change instructions substantially immediately within the limits of the protocol of the distributed power communication scheme. In one embodiment, a minimum time between transmissions may be in a range of from about one second to about three seconds, and in another embodiment or aspect, once every four to six seconds, and in a still further embodiment or aspect, once every eight to ten seconds. For example, during complex maneuvering in a complex environment and/or at greater speeds, the sampling rate may increase relative to a lower complexity and/or lower speed traversal of a simpler environment. The sampling rate may be the rate at which command messages (the same or different messages) are sent by the command vehicle. For example, at faster moving speeds of the vehicle group and/or during movements that require more changes in throttle settings or brake settings, the controller of the controlling vehicle may send command messages more often than when the vehicle group is moving at slower moving speeds and/or during movements that require fewer changes in throttle settings or brake settings.

When the command vehicle transmits a command message, the command vehicle may expect a status reply message from each remote vehicle of the vehicle group. This status reply message can indicate functional status or condition of the respective remote vehicle. For example, if a status reply message is not received from each remote vehicle, or if the command vehicle cannot otherwise determine the status of a remote vehicle (e.g., by other communications or sensors), the command vehicle may re-transmit the command message. If the status or condition of a remote vehicle is not determined in response to or based on the re-transmitted command message, the command vehicle may continue to repeatedly transmit the command message until the functional status of all remote vehicles is determined (e.g., by way of receipt or non-receipt of the status reply message from each remote vehicle).

The remote vehicle controller(s) may receive the command messages from the command vehicle. The remote vehicle controller(s) may transmit a respective remote status reply message in response to a trigger event. The receipt of a command message is a suitable trigger event while other trigger events may include the elapse of a determined time or a change in the operational state of a vehicle. For example, in one embodiment, the remote vehicle controller may generate a status reply message without prompting from the command vehicle (e.g., upon expiration of the predetermined time from receipt of a prior command message, upon expiration of the predetermined time from sending a prior status reply message, upon a change in a throttle setting or brake setting, etc.).

The status reply message sent from a remote vehicle may contain status data. Suitable status data may be indicative of the respective transmitting remote vehicle's actual operational status or condition. Other suitable status data may relate to the remote vehicle's correspondence, alignment, or conformance with instructions contained in the command message. Yet other suitable status data may include operating status, such as the speed, direction, orientation, of the remote vehicle or other objects or vehicles proximate to the remote vehicle (e.g., distance to a known stationary object). In one example, the status reply message of the remote vehicle may include data indicative of that respective remote vehicle's actual status related to at least one of the following: configurable settings, throttle settings, speed, direction, braking information, and/or air brake pressure information. Upon receipt of the status reply message by the command vehicle, this information is used by the command vehicle to determine whether the respective remote vehicle is following the appropriate command instructions in the command message. A remote vehicle's status reply message may also include data indicative of, associated with, or related to additional status or condition information of the respective remote vehicle. In one example, this additional information may relate to the traction motor current and/or main reservoir pressure. In another example, this additional information may relate to a fueling level, or a state-of-charge for energy storage. Other vehicle health information may be included.

To ensure that remote vehicles receive a command message, the controllers of the remote vehicle may be programmed or configured to repeat all or a portion of the command message within a respective remote vehicle's status reply message. Accordingly, if a remote vehicle, or any other remote vehicles within the vehicle group, cannot receive the command message directly from the command vehicle, then that remote vehicle may instead receive the command message as part of another remote vehicle's status reply message (and act on or implement the repeated command message accordingly). This condition may occur when a remote vehicle is out of radio range with the command vehicle.

Remote vehicles within the vehicle group may transmit the respective reply messages within sequential time slots that may be determined by a determined communications scheme. For example, after receiving a command message directly from the command vehicle, the first remote vehicle may transmit a status reply message in a first time slot, while the second remote vehicle may transmit its status reply message in a second time slot. The different time slots do not overlap each other in one embodiment. In another embodiment, at least two of the time slots partially but not entirely overlap each other. In another embodiment, at least two of the time slots entirely overlap each other. Each respective status reply message may include a repeat of the command message. If a remote vehicle receives the command message from another remote vehicle's status reply message (instead of directly from the command vehicle), then that remote vehicle may transmit its respective status reply message after other remote vehicles have transmitted their respective status reply messages.

FIG. 2 illustrates a diagrammatic representation of an example data structure of a remote status reply message 30, which may include a header portion 32, a remote status data portion 34, a remote command received count section 36, a repeated command function section or block 37, and an error check portion 38. The remote status data portion may include data indicative of the respective vehicle's actual status, such as with respect to the commands received in a lead command message 40. The actual status can indicate the throttle setting, brake setting, speed, location, acceleration, deceleration, or the like, of the remote vehicle. The remote command received count section may include one or more bits whose value can be incremented in response to or based on receipt of a status reply message from another remote vehicle. For example, the command received count section may include data or datum indicative of how many remote status reply messages have been received from other remote vehicles.

For example, a vehicle group with only two remote vehicles may require only a single bit remote “command received” count section. In one embodiment, a vehicle group with two, three, or four or more remote vehicles may use a multi-bit remote “command received” count section. The bits within the remote “command received” count section may not individually indicate that a respective remote vehicle has received the command message and/or is following the command instructions in the command message. That is, the “command received” count section may not require setting a respective bit for each remote vehicle. Instead, the “command received” count section represents a number of times that a status reply message has been received from another remote vehicle, without indicating the particular vehicles from which the status replies have been received. Alternatively, the same or another data field may include information identifying the specific remote vehicle(s) from which the status reply message was received. Identification may be through an identifier of the remote vehicle that transmits the status reply message that is included in the reply message. In one embodiment, the repeated command function section includes the command message or a portion of the command message.

The count of remote vehicles that have received the command message may be a number that increases for each additional remote vehicle that received the command message. For example, a count of two can indicate that two remote vehicles received the command message. This count may be increased to three when a third remote vehicle indicates receipt of the command message, to four when a fourth remote vehicle indicates receipt of the command message, and so on. The count may be re-set to an initial value (e.g., zero) once a different command message is sent, after expiration of a timer, or responsive to occurrence of another trigger event. Alternatively, the count of remote vehicles that have received the command message may be a number that decreases for each additional remote vehicle that received the command message. For example, this count may initially have a value that is the same as the number of remote vehicles in the vehicle group. The count may be decreased by one for each remote vehicle that indicates the command message was received by that vehicle. The count may decrease to a value of zero once all of the remote vehicles have indicated receipt of the command message. The value of the count may be re-set to an initial value (e.g., the same as the number of remote vehicles in the vehicle group) once a different command message is sent, after expiration of a timer, or responsive to occurrence of another trigger event.

The remote vehicle receiving a status reply message from another remote vehicle may not need to compare the received status reply message to a stored command message to determine whether another remote vehicle has received the command message, and/or is following the set of command instructions. Instead, the receipt of the status reply message, in or by itself, may be sufficient to cause the receiving remote vehicle to increment the count of how many remote vehicles received the command message. Accordingly, extra processing at the remote vehicle may be avoided.

FIG. 3 illustrates an example structure of a lead command message 40. The lead command message may include a header portion 44, a command functions portion 46, and an error check portion 48. The command functions portion 46 may include data indicative of the control instructions broadcast or transmitted by the command vehicle to the remote vehicles. The specific structures of the messages depicted in FIGS. 2 and 3 may differ and still accomplish the same result.

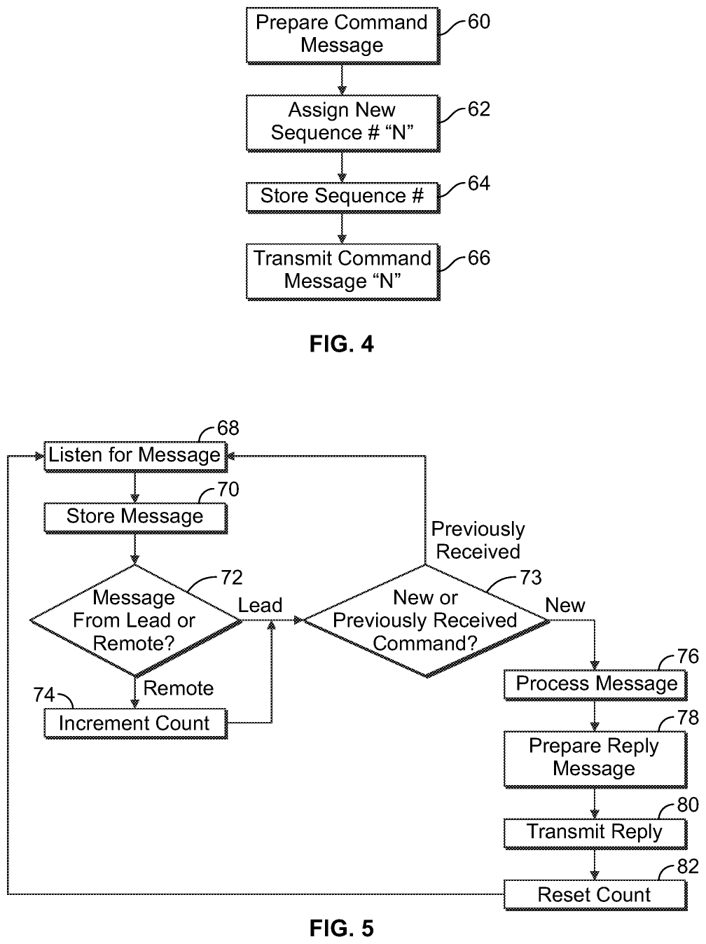

FIG. 4 is a flow chart showing a system and process for transmitting a lead command message according to one example. In step 60, the command vehicle prepares a command message “N” that may have a lead command message structure shown in FIG. 3. A new sequence number “N” may be assigned to the command message in step 62. The sequence number “N” may be stored in the database 22 of the command vehicle. Data indicative of the content of the associated command message (e.g., command message “N”) may be stored in database by the command vehicle in step 64. The command message may be generated or prepared using the on-board controller (or on-board processor(s)) of the command vehicle. The command vehicle transmits or broadcasts the command message “N” in step 66.

FIG. 5 is a flow chart showing a system and process for receiving a message at a remote vehicle according to one example. In one example, a remote vehicle waits to receive a message at step 68. For example, the command message “N” may be received directly by one or more remote vehicles in step 68. Instead of being received directly from the command vehicle, step 68 also allows for one or more remote vehicles to indirectly receive the command message “N” by virtue of the command message “N” being repeated in the status reply message of another remote vehicle (e.g., in the repeated command function section or block 37). The remote vehicle may store data indicative of the content of the received command message (or 37), including the sequence number “N” of the command section or block, in its onboard database 22, in step 70.

In step 72, the remote vehicle determines whether the received message is (i) a lead command message received directly from the command vehicle or (ii) another remote vehicle's status reply message that is “repeating” a lead command message (e.g., in the repeated command function section 37). For example, the received message may indicate the vehicle from which the message was directly sent, and the remote vehicle may check the received message to determine the vehicle from which the received message was directly sent. If the received message is another remote vehicle's status reply message that is “repeating” a lead command message (e.g., scenario (ii)), the remote vehicle may increment a current count in step 74. After incrementing the count in step 74, processing may proceed toward step 73 in which the remote vehicle determines whether the received message contains a new lead command or if the message contains a command that has previously been received. If the received message is a lead command message received directly from the command vehicle in step 72 (e.g., scenario (i)), processing can proceed toward step 73 in which the remote vehicle determines whether the received message contains a new lead command or if the message contains a command that has previously been received. For example, the remote vehicle may check the sequence number “N” of the command function section or block in the received message against the last stored sequence number in its on-board database 22 to determine whether the received message contains a new lead command or a command that has been previously received.

This test can be performed on all messages received by the remote vehicle, regardless of whether the message came from a command vehicle directly or was received from another remote vehicle. If the remote vehicle determines in step 73 that the received message includes a command that has been previously received, processing can return to step 68 in which the remote vehicle listens for further command messages 40 and status reply messages 30 broadcast by the command vehicle and other remote vehicles.

If, in step 73, the remote vehicle determines that the received message includes a new command message, processing may proceed toward step 76. The remote vehicle processes the associated command instructions included in the command message “N” so that the remote vehicle is set in the proper state of operation in step 76. For example, the controller of the remote vehicle may change a throttle setting and/or brake setting as directed by the command message. In step 78, the remote vehicle prepares a status reply message, which may contain data indicative of the actual status of remote vehicle pertaining to command message “N” and/or the current count of the remote vehicle. The actual status can be indicated by the changed throttle setting or brake setting of the remote vehicle, as directed by the command message (as one example). The current count may be indicated by the field or section in the message. In step 80, the remote vehicle transmits the status reply message to the command vehicle. Step 80, therefore, allows for a remote vehicle to transmit back to the command vehicle in response to or based on the receipt and processing of a command message by the remote vehicle.

A noted elsewhere herein, the current count can be stored by memory or an event recorder of the remote vehicle, by memory or an event recorder of the command vehicle, or by the combination thereof. The remote vehicle and/or the command vehicle can analyze the count data for radio management purposes and to determine problem areas. Problem areas may include one or more of communication errors, transmittal issues, corruption issues, and the like, in the communications network. For example, a remote vehicle that repeatedly loses communication with the lead vehicle (e.g., a number of communications losses for a period of time between the remote and lead vehicles exceeds a threshold), can indicate the presence of a problem in the communications network. In another example, a location of the remote vehicle and the command vehicle during a time period in which the current count was determined can be associated with the current count to determine areas in the route network where communication between the vehicles of the vehicle group has been diminished, lost, or failed. Location data for one or more vehicles of the vehicle group may be determined from a Positive Train Control (PTC) system, a vehicle control system, a location based device or tracking system, a route or travel plan indicating where a vehicle should be at a given time, notifications from wayside devices capable of recognizing the presence of a vehicle group, and a transmission/reception time of the message including the current count indicated by the field or section. In some implementations, the count data can be used to determine a need for radio repeaters or other communications mitigation between specific vehicles in the vehicle group and/or at specific locations in the route network.

After transmitting the status reply message in step 80, the remote vehicle may reset the current count of that vehicle to zero (or another value) at step 82, and processing may return toward step 68 for the remote vehicle to listen for further command messages sent by the command vehicle and/or status reply messages from the other remote vehicles.

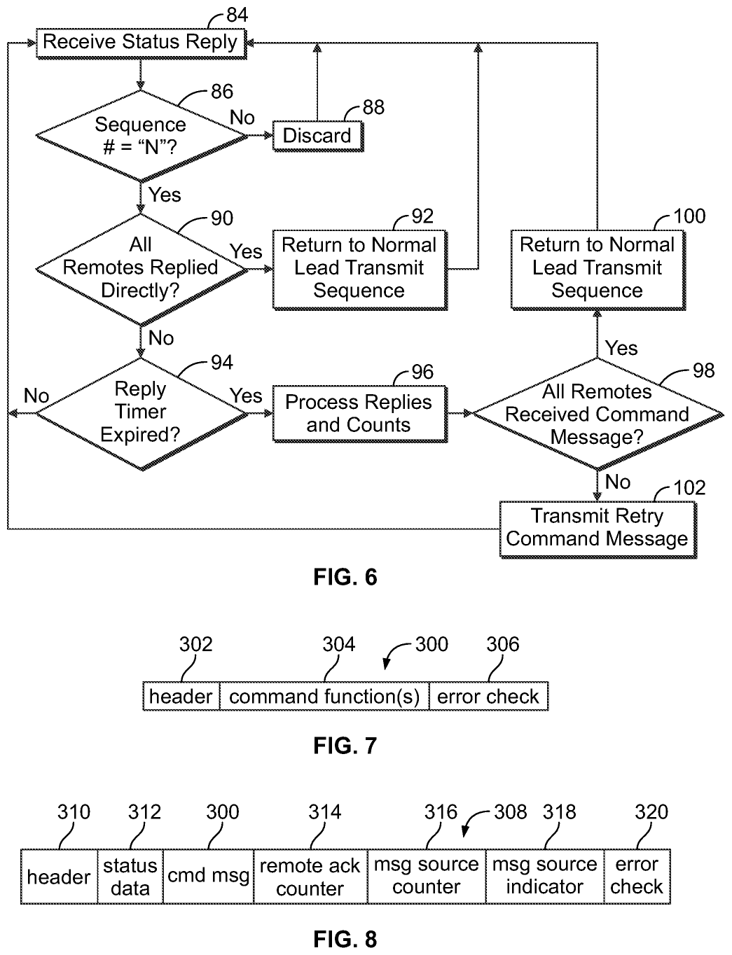

FIG. 6 is a flow chart showing a system and process for receiving remote status reply messages by a command vehicle according to one example. In step 84, the command vehicle may receive a remote vehicle's status reply message. The on-board processor(s) of the command vehicle may determine, in step 86, whether the sequence number of the command section or block in the received message equals the sequence number “N” for a current command message stored on-board the command vehicle. If the sequence numbers are not equal, the command vehicle may discard the received message in step 88, and processing returns to step 84 for the command vehicle to listen for further status reply messages.

If the sequence numbers match, the command vehicle controller may determine, in step 90, whether all remote vehicles within the vehicle group have now replied to the command vehicle with the respective command functions status. For example, the controller of the command vehicle may determine whether all remote vehicles within the vehicle group have now replied directly (or indirectly) to the command vehicle with the respective command function status within a first reply time period. The lead vehicle may determine whether all the remote vehicles within the vehicle group have now replied to the command vehicle based on a number of status reply messages received by the lead communication device of the lead vehicle and/or a number of remote vehicles or a number of status reply messages expected to be received. If all the remote vehicles within the vehicle group have replied directly to the command vehicle, the command vehicle returns the communication device 24, in step 92, to a normal lead transmit sequence, which may be defined by the protocol of the distributed power communications scheme operable among the vehicles within the vehicle group. In some implementations, the command vehicle provides an output to an operator of the command vehicle (e.g., via a driver display screen, a visual display unit, in the form of an audible alert, and/or the like) that receipt of a most recent command message by all remote vehicles is confirmed, or that receipt of the most recent command message by one or more of the remote vehicles cannot be confirmed.

If all remote vehicles have not replied directly to the command vehicle in step 86, the controller of the command vehicle may determine, in step 94, whether a reply timer has expired. The reply timer may be established as part of the distributed power communications scheme. If the reply timer has not expired, then the command vehicle may return to step 84, wherein the communication device 24 of the command vehicle continues listening for status reply messages. If the reply timer has expired, the controller of the command vehicle checks and processes, in step 96, the “command received” count section contained in each status reply message, to determine whether the command vehicle has received the status reply message directly from each respective remote vehicle in the vehicle group.

Each received status reply message, and each received “command received” count section of each received status reply message, may be processed in step 96 by the controller of the command vehicle to determine which of the remote vehicles have received the command message, either directly or indirectly. Each status reply message including the section may be decoded by the controller of the command vehicle to determine whether the remote vehicles have received the command message and/or are following the command message instructions.

After processing each received status reply message and each received “command received” count section of each received status reply message, the controller of the command vehicle, in step 98, determines whether all remote vehicles within the vehicle group have received the command message and/or are following the instructions contained within the command message. If it is determined that all remote vehicles have received the command message, the command vehicle returns the communication device 24 to a normal lead transmit sequence in step 100, which may be defined in the protocol of the distributed power communications scheme.

A remote vehicle may be considered to have received the command message if the command vehicle receives a status reply message directly from that remote vehicle, or if processing of the received status reply messages and the “command received” count section of each received status reply message at the command vehicle, determines that each remote vehicle received and/or processed the command message. If the controller of the command vehicle determines that that all remote vehicles within the vehicle group have received the command message and/or are following the instructions contained within the command message, the command vehicle may lessen the severity of its response to a one-way communication loss with a remote vehicle to a level that is less than its current response to a two-way loss of communications. For example, the command vehicle may lessen the severity of its response by not generating extra radio message queries, employing longer delays before applying operating restrictions, showing a one-way communications loss indication on the crew display, adding entries to an internal log, and/or not stopping or slowing the vehicle group.

If the on-board processor of the command vehicle determines, in step 98, that one or more remote vehicles have not received the command message, the communication device of the command vehicle may transmit or broadcast a retry command message, re-transmits or re-broadcasts, or takes other restrictive measures to respond to the determined two-way communications loss, in step 102. A retry command message (or the command message) may be broadcast with minimal time delay, such as about once every two to four seconds, for example. A communication loss or interruption warning or alarm condition may be activated by the controller of the command vehicle if the controller does not receive a command functions status message (or portion) 46 regarding each remote vehicle within a predetermined period of time. This period may vary depending on the criticality of the command functions broadcast to the remote vehicles. For example, this time period may be shorter for a brake command than for an acceleration command. All of the remote vehicles may be declared to be following the command instructions if all of the remote vehicles have received the command message.

In one embodiment, the instant communication status system and method can be effectively implemented for identifying a missed reply in a two-remote vehicle configuration (e.g., in a configuration with a command vehicle and only two remote vehicles). Specifically, the count in a scenario with only two remote vehicles would indicate whether the responding remote vehicle received a status reply message from the other remote vehicle. The lead or command vehicle (e.g., in step 98) can determine, based on the responding remote vehicle's status reply, whether all remote vehicles within the vehicle group have received the command message and/or are following the instructions contained within the command message.

A status reply count having a value that is less than the number of remote vehicles in the vehicle group may be received by the lead vehicle. For example, in a situation where the vehicle group includes three or more remote vehicles, e.g., remote vehicle (A), remote vehicle (B), and remote vehicle (C), two of the three remote vehicle's status reply messages may not be received by the lead vehicle. The remote vehicle (A) may only receive a response from one of the remote vehicles (B) or (C). The lead vehicle may not be able to determine which of the two or more remote vehicles (B) and (C) did not receive the lead vehicle command message (and/or which remote vehicle did receive the command message) in response to or based on a status reply message from remote unit (A) including a count of one (unless some other indication field is included in the status reply message, as discussed above). In particular, and in this embodiment or aspect with a specified status reply message, the on-board processor of the lead vehicle may be unable to determine which of the remote vehicles (B) or (C) is in a two-way communications loss, (e.g., which remote vehicle did not receive the command message in the first place), and which of the remote vehicles (B) or (C) is in a one-way communications loss (e.g., which remote vehicle received the command message but is unable to send a reply message). The on-board processor of the lead vehicle may still able to determine that a two-way communications loss exists. In such a situation, the system and method may include, e.g., at step 98, a determination that all remote vehicles have not received the command message, and that the lead vehicle should transmit or broadcast a retry command message (or re-transmit or re-broadcast the command message), e.g., at step 100.

If the lead vehicle receives a status reply message from less than all of the remote vehicles (or a status reply count having a value that is less than the number of remote vehicles in the vehicle group), the lead vehicle may determine, by process of elimination, which of the remote vehicles did not receive the lead command message. The lead vehicle may use the count sections (e.g., the field or section of the status reply message) received from each of the remote vehicles that provided a status reply (e.g., vehicles (A) and (B)) to determine whether other remote vehicles (e.g., the remote vehicle (C)) received the lead command message, as long as the count of one of the remote vehicles providing the status reply count to the lead vehicle is at least equal to the number of remote vehicles minus one (e.g., the vehicle (C)). However, it is envisioned that a scenario may arise where the count of each of the replying remote vehicles is less than the number of remote vehicles minus one (e.g., the status reply received from each remote vehicle (A), (B) includes a count value of only one). In This situation, the lead vehicle may be unable to determine whether the remote vehicle (C) received the lead command message. That is, remote vehicles (A) and (B) may have incremented each other's counts. In such a situation, the system and method may include, e.g., at step 98, a determination that all remote vehicles have not received the command message, and that the lead vehicle should transmit or broadcast a retry command message (or re-transmit or re-broadcast the command message), e.g., at step 100. Alternatively, if the lead vehicle receives a status reply message from only one of the three remote vehicles, e.g., remote vehicle (A), that includes a count of two, the on-board processor of the lead vehicle may determine that each of the other remote vehicles (B) and (C) have received the command message and, thus, are in only a one-way communications loss. Processing at the first, lead or command vehicle for a vehicle group having more than three remote units may have a particular remote vehicle sending the message, and its respective count, as discussed herein.

A lead communication device 24 (e.g., a lead transceiver unit) of a command vehicle may be provided to function interoperably with a communication device (e.g., a transceiver unit) of a remote vehicle to execute distributed power communication functions for implementing aspects of the subject matter described herein. The respective on-board controller may be programmed or configured to allow for the lead communication device to determine which remote communication devices from among a plurality of remote communication devices located at spaced locations along the vehicle group are in receipt of a command message and/or are executing instructions associated with command functions of the command message. One example embodiment or aspect allows for the respective on-board control systems and/or the communication devices to be programmed or configured such that when the lead communication determines that a respective remote communication device is in receipt of a command message, that an associated remote vehicle is following the command functions of the command message.

The on-board control system of the lead vehicle may determine a communication status for the vehicle group responsive to receiving response messages from the remote vehicles. In one embodiment, the vehicle group is a train consist, in another embodiment the vehicle group is a drone swarm, in another embodiment the vehicle group is a convoy of vehicles, and so on. The communication status that is determined may be, for example, representative of a group-wide quality of service of communications between or among the vehicles. The on-board control system of the lead vehicle may generate a quality of service indication, which can be a quantitative value indicative of the quality of service. Alternatively, the quality of service determination (and subsequent indication) may be generated by a handheld apparatus regardless of location relative to any vehicles in the vehicle group, by a back office system in communication with any of the vehicles in the vehicle group, by a vehicle in the vehicle group that is not the lead vehicle, and/or by a wayside device that is neither a vehicle or a part of the vehicle group. The indication may be in the form of a metric, chart, report, and/or the like, that is reported to a network or vehicle operator, a back office system, and/or other parties. The group-wide quality of service may be with respect to a quality of transmission, a quality of reception, the strength of transmission or reception, the frequency of dropped service over a determined period, the frequency of dropped service in a determined region, other factors that may affect quality of service (such as network volume, network lag/ping rates, hardware considerations, software considerations, protocol translation requirements, power consumption levels, and environmental factors), and/or combinations of two or more of the foregoing. Hardware and software considerations may include generational communication gaps, such as whether the wireless service is a 3G, 4G, 5G, etc. system, or whether the system requires the use of a GSM cellular system, a radio-based system, or a satellite comm system. In one embodiment, the controller of the lead vehicle may monitor the message source counter for each response message received and, based on the message source counters, determine a number of remote vehicles that received the command message from the lead vehicle. Additional information about the vehicles in the vehicle group and the communication network may be obtained.

FIGS. 7 and 8 illustrate, respectively, a command message 300 and a response message 308 according to an embodiment. The sections 302, 304, 306, 310, 312, 314, 316, 318, 320 of the messages 300 and 308 may be a determined number of bits, fixed or variable-sized fields in a data structure, and/or the like. The sections 302, 304, 306, 310, 312, 314, 316, 318, 320 may be alphanumeric strings, characters, integers, binary values, and/or another type of variable depending on application specific parameters. The command message 300 and response message 308 may be one or more objects in an object-oriented hierarchy, a plurality of smaller messages, or another type of data structure capable of specifying parameters and/or conveying information.

The command message 300 shown in the embodiment of FIG. 7 includes a header 302, a command function(s) section 304, and an error check section 306. It will be appreciated that various other sections may be included in the command message 300 and that the command message 300 may be structured in any number of other ways. The header 302 may include one or more identifiers that identify the source of the command message 300, such as a lead vehicle, as well as the remote vehicles that are to receive and act upon the command message 300. The header 302 may include a sequence number or other like variable to uniquely distinguish between different command messages. In some examples, the sequence number may be a separate field of the command message. The command function(s) section may include various commands for the remote vehicle to execute. Suitable commands may include one or more of distributed power operation command, direction change, operational mode changes, the start/stop of various equipment on-board a vehicle, and the like. In some examples, the command message may convey information to the remote vehicles and not necessary trigger an operational change. The error check section may be a checksum or any other like form of data to enable verification by a recipient vehicle that the message is intact and valid.

The response message 308 shown in the embodiment of FIG. 8 may include a header 310, a status data section 312, a command message 300, a remote acknowledgement count section 314, a message source count section 316, a message source indicator section 318, and an error check section 320. The header 310 may include one or more identifiers that identify the source of the response message, such as the remote vehicle that generates and transmits such a message. The status data section 312 may include data representative of one or more statuses of the remote vehicle and an acknowledgement of receipt, as examples. The command message 300 may be the command message received by the remote vehicle generating the response message 308 (or a portion thereof), either from the lead vehicle or from another response message 308 including the command message 300. The remote acknowledgement count section 314 may be a value of a programmatic counter that indicates a number of response messages received by other remote vehicles. The message source count section 316 may be a value of a programmatic counter that indicates a number of response messages received by other remote vehicles that, in turn, received a command message directly from the lead vehicle. The message source indicator section 318 may be a value of a semaphore, such as but not limited to a flag or other like variable, that indicates either a first state in which the remote vehicle generating the response message 308 received the command message directly from the lead vehicle, or a second state in which the remote vehicle generating the response message 308 did not receive the command message directly from the lead vehicle but, instead, received it from a response message transmitted by another remote vehicle. The value of the message source indicator section may represent a state or mode in any number of ways, such as “LEAD” and “REMOTE,” a binary representation of true (1) or false (0), or may be non-binary data concerning the status and/or state of the remote vehicle.

In one embodiment, a method is provided that includes transmitting a command message by a lead communication device of a lead vehicle, receiving the command message by a plurality of communication devices of a respective plurality of remote vehicles, and transmitting a status reply message (by a communication device of at least one remote vehicle of the plurality of remote vehicles) in response to receipt of the command message. At least a portion of the command message may be repeated within the status reply message. The method may include receiving the status reply message by a communication device of at least one other remote vehicle of the plurality of remote vehicles. This status reply message may include the repeated portion or entirety of the command message. The method also may include incrementing a current status reply count at the at least one other remote vehicle of the remote vehicles. This count can be incremented in response to the receipt of the status reply message including the repeated at least a portion of the command message from the at least one remote vehicle of the plurality of remote vehicles. The method may include transmitting an expanded status reply message by the communication device of the at least one other remote vehicle of the remote vehicles. This reply message may include the current status reply count to the lead communication device of the lead vehicle. The method may include receiving the expanded status reply message by the lead communication device of the lead vehicle, and determining a communications status of a communication device of the at least one remote vehicle with respect to the command message. This status may be determined by on-board processor(s) of the lead vehicle. The status may be determined based at least partly on the current status reply count in the expanded status reply message received from the at least one other remote vehicle. The method also may include controlling at least one of a throttle and/or a brake of the vehicle group by the on-board processor of the lead vehicle. The throttle and/or brake may be controlled based on the determined communications status of the communication device of the at least one remote vehicle with respect to the command message.

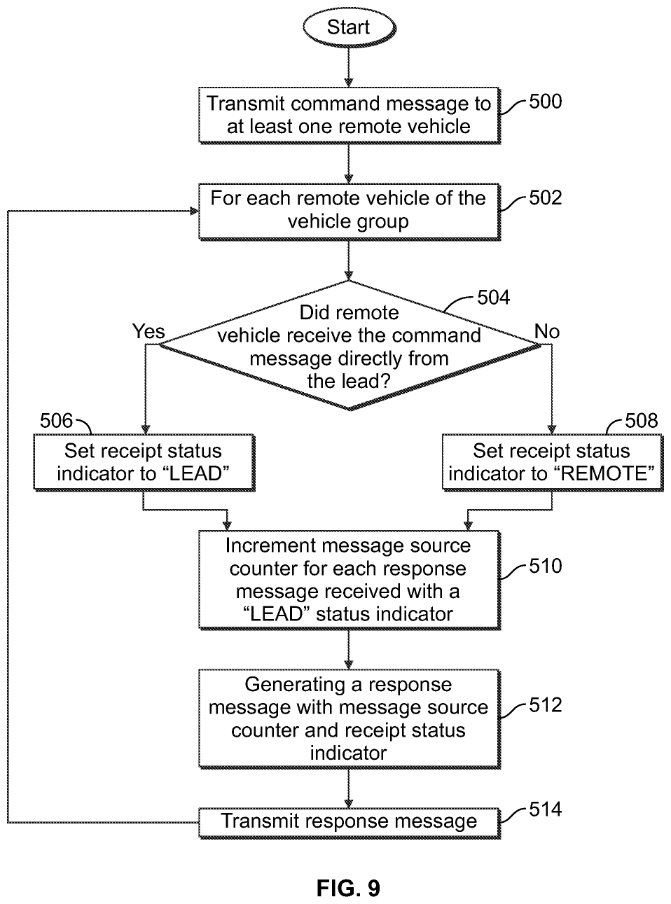

Referring now to FIG. 9, a method for determining a communication status of vehicles in a distributed power system is shown according to an embodiment. At a step 500, a lead vehicle transmits a command message to a plurality of remote vehicles in a vehicle group. At step 502, a process is carried out for each of the remote vehicles. For each remote vehicle in a consist (e.g., a member of the vehicle group), an on-board system of the remote vehicle may determine whether the command message was received directly from the lead vehicle at step 504. This determination may be made by analyzing the data received, including but not limited to a header of a command message, to identify the source of the data. Alternatively, the inverse can be done where the determination is whether the message was received indirectly (e.g., via another non-lead vehicle or a wayside device).

With continued reference to FIG. 9, if it is determined that the command message was received directly from the lead vehicle at step 504, at step 506 the message source indicator of the remote vehicle is set to a first state (e.g., “LEAD”). If it is determined at step 504 that the command message was not received directly from the lead vehicle, but rather received indirectly, at step 508 the message source indicator of the remote vehicle is set to a second state (e.g., “REMOTE”). Once the message source indicator is set to either a first or second state, at step 510 the message source counter of the remote vehicle is incremented for each response message received from other remote vehicles in which the message source indicator is set to the first state (e.g., for each response message received from a remote vehicle that itself received the command message directly from the lead vehicle). The remote acknowledgement counter of the remote vehicle may be incremented in response to receiving a command message directly or indirectly from the lead vehicle (not shown in FIG. 9). Alternatively, if the message is receive both directly and indirectly, an embodiment of the invention may account for that situation as well.

Still referring to FIG. 9, at step 512 a response message may be generated by the remote vehicle that includes at least values of the message source counter and the message source indicator. A suitable response message may be generated by the remote vehicle at a determined interval, and/or in response to receiving a message, or the occurrence of some other event. At step 514, the response message is transmitted such that the message can be received by a receiver within range and capable of receiving the message. The method may then return to step 502 to repeat steps 504, 506 or 508, 510, 512, and/or 514 for one or more of the remote vehicles. In one embodiment, each remote vehicle in the vehicle group may perform at least steps 512 and 514 at staggered time intervals, such that each remote vehicle generates and transmits a respective response message at respective times.

As used herein, the terms “communication”, “communicatively coupled”, “virtually coupled”, and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that may be wired and/or wireless in nature. Additionally, two units or components may be in communication with each other even though the data transmitted may be modified, processed, routed, and the like, between the first and second unit or component. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit.

In one embodiment, one or more of the controller may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following clauses, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. Other embodiments will be apparent to one of ordinary skill in the art upon reviewing the above description. The scope of the subject matter should, therefore, be determined with reference to the appended claims, along with the full scope of equivalents to which such clauses are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system for controlling at least one vehicle in a vehicle group that includes controlled vehicles comprising:
a communication device that is configured to send a command message to the controlled vehicles, the communication device configured to receive a status reply message from at least a first controlled vehicle of the controlled vehicles, the status reply message including a count indicative of a number of the controlled vehicles that received the command message from the communication device; and
a controller configured to examine the count included in the status reply message and determine a communications status of the vehicle group based at least partly on the count in the status reply message.

2. The system of claim 1, wherein the controller is further configured to control at least one of a throttle or power consumption rate, brake, steering, yaw, or elevation of the controlled vehicles based at least in part on the communication status that is determined.

3. The system of claim 1, wherein the communication device is configured to receive the status reply message that includes at least a repeated portion of the command message sent from the communication device to the controlled vehicles.

4. The system of claim 1, wherein the controller is configured to examine the count that represents a number of times that the status reply message was received by at least one of the controlled vehicles.

5. The system of claim 1, wherein the controller is disposed on a controller vehicle that is a member of the vehicle group.

6. The system of claim 1, wherein the status reply message further include one or both of a signal strength and a distance between the communication device and the controlled vehicle.

7. The system of claim 1, wherein the controlled vehicles are rail vehicles.

8. The system of claim 1, wherein the controlled vehicles are mining vehicles, automobiles or aerial drones.

9. The system of claim 1, wherein the controller is configured to change a state of the controlling vehicle to one of the controlled vehicles.

10. A method comprising:
sending a command message from a controller to controlled vehicles in a vehicle group;
receiving a status reply message at the controller from at least a first controlled vehicle of the controlled vehicles, the status reply message including a count indicative of a number of the controlled vehicles that received the command message from the controller vehicle; and
determining a communications status of the vehicle group based at least partly on the count in the status reply message.

11. The method of claim 10, wherein the status reply message includes statuses of different controlled vehicles of the controlled vehicles.

12. The method of claim 10, further comprising controlling movement of the controlled vehicles based on the communication status that is determined.

13. The method of claim 12, wherein the movement of the controlled vehicles is controlled in different restrictive manners based on the count in the status reply message.

14. The method of claim 10, wherein the controller is disposed on a controller vehicle and further comprising switching a first status of the controller vehicle to one of the controlled vehicles and a second status of a first controlled vehicle to the controller vehicles based on the count in the status reply message.

15. The method of claim 10, further comprising:
determining which of the controlled vehicles received the command message; and
generating or providing an output onboard the controller vehicle indicating at least one of receipt of the command message by each of the controlled vehicles or receipt of the command message by less than all of the controlled vehicles.

16. A system for controlling one or more controlled vehicles in a vehicle group comprising:
a communication device configured to send a command message to the controlled vehicles to control movement of the vehicle group, the communication device configured to receive a status reply message from one or more of the controlled vehicles, the status reply message including a count indicative of a number of the controlled vehicles that confirmed receipt of the command message from the communication device; and
a controller configured to examine the count included in the status reply message, determine a communications status of the vehicle group based at least partly on the count in the status reply message, and change movement of the vehicle group based on the communication status.

17. The system of claim 16, wherein the controller is configured to change movement of the vehicle group by sending another command message that changes at least one of a throttle or power consumption rate, brake, steering, yaw, or elevation of the controlled vehicles.

18. The system of claim 16, wherein the communication device is configured to receive the status reply message that includes at least a repeated portion of the command message sent from the communication device to the controlled vehicles.

19. The system of claim 16, wherein the controller is configured to examine the count that represents a number of times that the status reply message was received by at least one of the controlled vehicles.

20. The system of claim 16, wherein the controller is disposed on a controller vehicle that is a member of the vehicle group, and the controlled vehicles are one or more of aerial drones, automobiles, rail vehicles, or mining vehicles.
